(19) United States
(12) Patent Application Publication
(10) Pub. No.: US 2006/0160924 A1
(43) Pub. Date: Jul. 20, 2006

(54) Inkjet recording ink, inkjet recording method, ink cartridge, and inkjet recording system

(76) Inventors: Suzuka Kakuchi, Joso-shi (JP); Yukiko Tachibana, Joso-shi (JP); Tomoya Yamamoto, Joso-shi (JP)

Correspondence Address: HARNESS, DICKEY & PIERCE, P.L.C., P.O. BOX 8910, RESTON, VA, 20195, US

(21) Appl. No.: 11/334,431

(22) Filed: Jan. 19, 2006

(30) Foreign Application Priority Data
Jan. 20, 2005 (JP) JP 2005-013144

(51) Int. Cl. C03C 17/00

(52) U.S. Cl. 523/160

(57) ABSTRACT

An inkjet recording ink contains a high-molecular dispersant, a water-insoluble colorant, a co-solvent, and water as principal components. The co-solvent is composed at least of (a) a polyol-alkylene oxide adduct represented by the following formula 1 and (b) an ethylene oxide-propylene oxide block copolymer represented by the following formula 2 or 3: 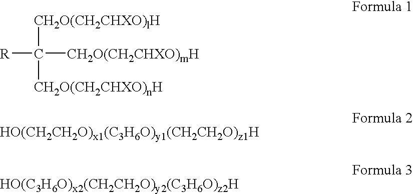
wherein R represents a lower alkyl group or —CH₂O(CH₂CHXO)ₖH (X: H or CH₃, k: 1 to 20), l+m+n is 3 to 60; x1+z1 is 4 to 100, and y1 is 1 to 50; and x2+z2 is 2 to 100, and y2 is 2 to 50.

### FIELD OF THE INVENTION

This invention relates to inkjet recording inks (hereafter simply called “inks”), an inkjet recording method, ink cartridges, and an inkjet recording system. More specifically, the present invention is concerned with water-based inks of the colorant dispersion type, which are high in ejection stability, good in the color-developing ability of a printed ink and suited for inkjet recording, and also with an inkjet recording method, ink cartridges and inkjet recording system all of which make use of the inks.

### DESCRIPTION OF THE BACKGROUND

As colorants for printing inks, water-insoluble colorants excellent in fastness such as waterproofness and light fastness, for example, pigments have been used widely to date. To use a water-insoluble colorant as a colorant for a water-based ink, it is required to stably disperse the water-insoluble colorant in an aqueous medium. Water-based inks of the colorant dispersion type are hence used, each of which contains a water-insoluble colorant evenly dispersed in an aqueous medium by the addition of a dispersant such as a high-molecular compound or surfactant.

In recent years, water-based inks of this colorant dispersion type have been also finding utility as inkjet recording inks from the standpoint of image fastness. In inkjet recording, it is attempted to provide dispersed colorant particles, which are dispersed in an ink, with a cohesive property and water insolubility so that the ink would be able to exhibit an improved fixing property and improved waterproofness on paper. The provision of such properties to the dispersed colorant particles, however, leads to a reduction in dispersion stability, thereby developing potential problems such that the dispersed colorant particles may cohere during storage of the ink, uneven print density and settling tend to occur, and due to drying of the ink, clogging tends to occur at nozzle tips of an inkjet recording system to result in reduced ejection stability. In addition, the dispersed colorant particles are apt to aggregate on the surface of the printed material; the coherent particles give rise to scattered light; and the scattered light reduce greatly the color saturation of the ink on the printed material. As results, the printed image has such a problem that its color-developing property reduces owing to great reduction in the color saturation.

In an attempt to solve the above-described problems, JP-B-2714485 proposes an ink containing a polyol-alkylene oxide adduct. The mere addition of the polyol-alkylene oxide adduct, however, is still unable to solve the problems in long-term ink storage stability and ejection stability, although it may be effective for a short term.

JP-A-2002-167533, on the other hand, proposes an ink containing a triol-alkylene oxide adduct and a specific organic solvent. This ink is effective to some extent for the color-developing property of a printed image, but its dispersion stability tends to decrease when its composition substantially changes as in its unavoidable concentration at nozzle tips when used in an inkjet system. Coupled with the substantial adhesion of dispersed colorant particles on the peripheral parts of nozzles in the inkjet system, non-ejection and print misalignments tend to occur so that the ejection stability is still below the satisfactory level. This problem is serious especially in an inkjet system equipped with line printheads the inkjet nozzles of which do not permit frequent cleaning and refreshing operations.

### SUMMARY OF THE INVENTION

With the foregoing problems in view, the present invention, therefore, has as objects thereof the provision of an ink capable of stably recording images of high fastness and excellent quality over a long term even under severe environmental conditions and also the provision of an inkjet recording method, ink cartridge and inkjet recording system all of which make it possible to record images of superb fastness and quality.

The present inventors have proceeded with an extensive investigation to solve the above-described problems. As a result, it has been found that they can be solved by the invention to be described hereinafter. Described specifically, the present invention provides an inkjet recording ink comprising a high-molecular dispersant, a water-insoluble colorant, a co-solvent and water, wherein the co-solvent comprises:

(a) a polyol-alkylene oxide adduct represented by the following formula 1: 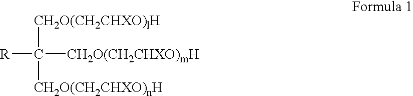
wherein R represents an alkyl group having a carbon number of not greater than 4 or —CH₂O(CH₂CHXO)ₖH in which X represents H or CH₃ and k is 1 to 20, and l+m+n is 3 to 60; and

(b) an ethylene oxide-propylene oxide block copolymer represented by the following formula 2 or (3):
HO(CH₂CH₂O)ₓ₁(C₃H₆O)_{y1}(CH₂CH₂O)_{z1}H Formula 2
wherein x1+z1 is an integer of from 4 to 100, and y1 is an integer of from 1 to 50, or
HO(C₃H₆O)ₓ₂(CH₂CH₂O)_{y2}(C₃H₆O)_{z2}H Formula 3
wherein x2+z2 is an integer of from 2 to 100, and y2 is an integer of from 2 to 50.

In the present invention, the polyol-alkylene oxide adduct (a) may preferably be at least one adduct selected from the group consisting of a trimethylolpropane-ethylene oxide adduct (l+m+n=3 to 30), a trimethylolpropane-propylene oxide adduct (l+m+n=3 to 30) and a pentaerythritol-ethylene oxide adduct (k+l+m+n=4 to 40).

In the present invention, a ratio of an average number of alkylene oxide units in the ethylene oxide-propylene oxide block copolymer (b) to an average number of alkylene oxide units in the polyol-alkylene oxide adduct (a) may preferably be in a range of from 1 to 20; a ratio of a weight of the ethylene oxide-propylene oxide block copolymer (b) in the ink to a weight of the polyol-alkylene oxide adduct (a) in the ink may preferably be in a range of from 0.01 to 1; and a ratio of a total number of alkylene oxide units in the ethylene oxide-propylene oxide block copolymer (b) to a total number of alkylene oxide units in the polyol-alkylene oxide adduct (a) may preferably be in a range of from 0.01 to 2.

In the present invention, the high-molecular dispersant may preferably be a block copolymer comprising hydrophobic blocks formed from at least one vinyl ether and hydrophilic blocks formed from at least one vinyl ether, and the hydrophilic blocks in the high-molecular dispersant may preferably comprise blocks formed from a vinyl ether having a nonionic hydrophilic group and blocks formed from a vinyl ether having an anionic hydrophilic group; and more preferably, the high-molecular dispersant may be formed of a recurrence of at least a block formed from a hydrophobic vinyl ether, a block formed from a hydrophilic vinyl ether having a nonionic hydrophilic group and a block formed from a hydrophilic vinyl ether having an anionic hydrophilic group arranged in this order.

In addition, the water-insoluble colorant may preferably be a pigment in the present invention.

Further, the present invention also provides an inkjet recording method comprising applying energy to an ink to cause the ink to fly onto a recording material, wherein the ink is any one of the above-described inkjet recording inks according to the present invention. In the inkjet recording method, the energy may preferably be thermal energy; and the recording material may preferably be provided on at least one side thereof with an ink-receiving coating layer.

Furthermore, the present invention also provides an ink cartridge provided with an ink reservoir with an ink accommodated therein, wherein the ink is one of the above-described inks according to the present invention.

Still furthermore, the present invention also provides an inkjet recording system having an ink cartridge provided with an ink reservoir with an ink accommodated therein and a printhead portion for ejecting the ink, wherein the ink is any one of the above-described inks according to the present invention.

According to the present invention, it is possible to provide inks capable of stably recording images of high fastness and excellent quality over a long term even under severe environmental conditions, and further, an inkjet recording method, ink cartridges and inkjet recording systems all of which make it possible to record images of superb fastness and quality.

### BRIEF DESCRIPTION OF THE DRAWINGS

FIG. 1 is a schematic diagram for describing the construction of an ink cartridge.

FIG. 2 is a schematic diagram for describing the construction of an inkjet recording head.

FIG. 3 is a partly see-through view of an inkjet recording system.

FIG. 4 is a schematic diagram of a refreshing system in the inkjet recording system.

FIG. 5 is a schematic diagram showing another illustrative construction of the inkjet recording head.

### DETAILED DESCRIPTION OF THE INVENTION AND PREFERRED EMBODIMENTS

The present invention will hereinafter be described in detail.

The present inventors have found that in an inkjet recording ink comprising a high-molecular dispersant, a water-insoluble colorant, a co-solvent and water, the inclusion of (a) a polyol-alkylene oxide adduct represented by the following formula 1: 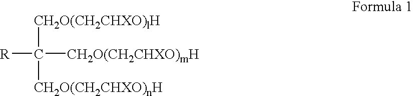
wherein R represents an alkyl group having a carbon number of not greater than 4 or —CH₂O(CH₂CHXO)ₖH in which X represents H or CH₃ and k is 1 to 20, and l+m+n is 3 to 60; and

(b) an ethylene oxide-propylene oxide block copolymer represented by the following formula 2 or (3):
HO(CH₂CH₂O₂)ₓ₁(C₃H₆O)_{y1}(CH₂CH₂O)_{z1}H Formula 2
wherein x1+z1 is an integer of from 4 to 100, and y1 is an integer of from 1 to 50, or
HO(C₃H₆O)ₓ₂(CH₂CH₂O)_{y2}(C₃H₆O)_{z2}H Formula 3
wherein x2+z2 is an integer of from 2 to 100, and y2 is an integer of from 2 to 50, as the co-solvent makes it possible to stably record images of high fastness and excellent quality even under severe environmental conditions.

As the polyol-alkylene oxide adduct is equipped with good compatibility with the dispersed colorant particles in the ink and has a branched structure, the polyol-alkylene oxide adduct and the dispersed colorant particles in the ink are three-dimensionally compatibilized so that the cohesion of the dispersed colorant particles is suppressed to result in a reduction in the cohesion force among the dispersed colorant particles themselves. The combined use of the ethylene oxide-propylene oxide block copolymer having a structure of strong compatibility with the alkylene oxide moiety of the polyol-alkylene oxide adduct has made it possible to exhibit a bridging effect for the aqueous medium and the polyol-alkylene oxide adduct, thereby improving the compatibility of the polyol-alkylene oxide adduct in the aqueous medium. This is considered to contribute to an improvement in the stability of the dispersed colorant particles compatibilized with the polyol-alkylene oxide adduct.

In other words, the polyol-alkylene oxide adduct is considered to exhibit its effect of preventing a reduction in the color-developing property on the surface of a recording material by preventing the cohesion of the dispersed colorant particles themselves. This effect, contrariwise, acts to lower the dispersion stability of the dispersed colorant particles in the ink. The combined use of the ethylene oxide-propylene oxide block copolymer is, however, considered to make it possible to improve the stability of the dispersed colorant particles in the ink.

The use of a polyol-alkylene oxide adduct in which the number of alkylene oxide units has been controlled to a particular range can provide higher compatibility with the ethylene oxide-propylene oxide block copolymer, thereby making it possible to further improve the stability of the dispersed colorant particles in the ink.

Owing to these effects, the ink according to the present invention is free from the reduction in the color-developing property, which would otherwise take place due to the cohesion of dispersed colorant particles on the surface of a recording medium as a drawback of an ink of the colorant dispersion type, and moreover, permits stable ejection without any substantial reduction in dispersion stability even when the composition of the ink varies considerably as in the unavoidable concentration of the ink at nozzle tips when used in an inkjet system. In addition, even with an inkjet system equipped with line printheads the inkjet nozzles of which do not permit frequent cleaning and refreshing operations, the adhesion of dispersed colorant particles on the peripheral parts of nozzles, non-ejection and print misalignments hardly occur so that good continuous printing performance can be achieved over a long term.

A more detailed description will hereinafter be made about the components of the ink according to the present invention.

(Polyol-Alkylene Oxide Adduct)

The polyol-alkylene oxide adduct useful in the ink according to the present invention is a compound having a structure represented by the following formula 1: 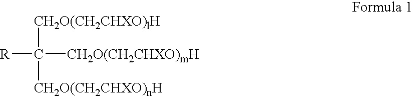
wherein R represents an alkyl group having a carbon number of not greater than 4 or —CH₂O(CH₂CHXO)ₖH in which X represents H or CH₃ and k is 1 to 20, preferably 1 to 10, and l+m+n is 3 to 60, preferably 3 to 30. It is to be noted that the values in these ranges in the present invention indicate average values, respectively. If l+m+n is smaller than 3 or k is smaller than 1, the polyol-alkylene oxide adduct is provided with reduced compatibility with the ethylene oxide-propylene oxide block copolymer, so that the dispersed colorant particles tend to be provided with reduced stability in the ink. If l+m+n is greater than 60 or k is greater than 20, on the other hand, the polyol-alkylene oxide adduct is provided with reduced compatibility with the dispersed colorant particles, so that printed images tend to be provided with a reduced color-developing property.

The polyol-alkylene oxide adduct may preferably be at least one adduct selected from the group consisting of a trimethylolpropane-ethylene oxide adduct (l+m+n=3 to 30), a trimethylolpropane-propylene oxide adduct (l+m+n=3 to 30) and a pentaerythritol-ethylene oxide adduct (k+l+m+n=4 to 40), with the trimethylolpropane-ethylene oxide adduct (l+m+n=3 to 30) being more preferred. The use of such a preferred polyol-alkylene oxide adduct is desired, because printed images are provided with a further improved color-developing property.

As such polyol-alkylene oxide adducts, it is preferred to use, in addition to those available on the market, those prepared by adding alkylene oxides such as ethylene oxide and propylene oxide to polyols such as trimethylolpropane in the presence of a base catalyst by a method known per se in the art such as the vapor-phase method or the liquid-phase method. Concerning the number or the like of alkylene oxide units in each polyol-alkylene oxide adduct, a determination is feasible through qualitative and quantitative analyses of functional groups by NMR and IR and through analyses by various chromatographic methods. The content of the polyol-alkylene oxide adduct in the ink may preferably be in a range of from 0.5 to 10 wt. %.

(Ethylene Oxide-Propylene Oxide Block Copolymer)

The ethylene oxide-propylene oxide block copolymer useful in the ink according to the present invention is a compound having a structure represented by the following formula 2 or (3):
HO(CH₂CH₂O)ₓ₁(C₃H₆O)_{y1}(CH₂CH₂O)_{z1}H Formula 2
HO(C₃H₆O)ₓ₂(CH₂CH₂O)_{y2}(C₃H₆O)_{z2}H Formula 3
wherein x1+z1 is an integer of from 4 to 100, y1 is an integer of from 1 to 50, x2+z2 is an integer of from 2 to 100, and y2 is an integer of from 2 to 50. It is to be noted that the values in these ranges in the present invention indicate average values, respectively. Unless x1 to z2 satisfy the above-specified ranges, the ethylene oxide-propylene oxide block copolymer is provided with reduced compatibility with the polyol-alkylene oxide adduct and/or the aqueous medium, so that the dispersed colorant particles tend to be provided with reduced stability. Among such ethylene oxide-propylene oxide block copolymers, an ethylene oxide-propylene oxide block copolymer of the formula 3 is preferred as it can readily provide the dispersed colorant particles with further improved stability.

As such ethylene oxide-propylene oxide block copolymers, it is preferred to use, in addition to those available on the market, those prepared by adding ethylene oxide and propylene oxide to polypropylene glycol and polyethylene glycol in the presence of a base catalyst by a method known per se in the art such as the vapor-phase method or the liquid-phase method. Concerning the numbers of ethylene oxide units and propylene oxide units in each ethylene oxide-propylene oxide block copolymer, determinations are feasible through qualitative and quantitative analyses of functional groups by NMR and IR or through analyses by various chromatographic methods.

As the content of the ethylene oxide-propylene oxide block copolymer in the ink, desired is such a content that relative to the polyol-alkylene oxide adduct also contained in combination, the ratio of the average number of alkylene oxide units in the ethylene oxide-propylene oxide block copolymer to the average number of alkylene oxide units in the polyol-alkylene oxide adduct falls within the range of from 1 to 20 or the ratio of a weight of the ethylene oxide-propylene oxide block copolymer in the ink to a weight of the polyol-alkylene oxide adduct in the ink falls within the range of from 0.01 to 1. This desired content leads to still better compatibility between the polyol-alkylene oxide adduct and the ethylene oxide-propylene oxide block copolymer, thereby providing the dispersed colorant particles with improved stability. More desired is such a content that the ratio of the total number of alkylene oxide units in the ethylene oxide-propylene oxide block copolymer in the ink to the total number of alkylene oxide units in the polyol-alkylene oxide adduct in the ink falls preferably within a range of from 0.01 to 2, more preferably within a range of from 0.1 to 1.0. This more desired content leads to best compatibility between the polyol-alkylene oxide adduct and the ethylene oxide-propylene oxide block copolymer, thereby providing the dispersed colorant particles with further improved stability and permitting still more stabilized ink ejection.

(High-Molecular Dispersant)

As the high-molecular dispersant for use in the ink according to the present invention, any high-molecular compound can be used insofar as it contains at least one unit having hydrophilicity and at least one unit having hydrophobicity in combination and acts as a dispersant for the water-insoluble colorant. Among such high-molecular compounds, those containing one or more units with anionic hydrophilic groups as a unit or units having hydrophilicity can be used preferably. As such high-molecular dispersants, high-molecular compounds obtained by polymerizing vinyl monomers can be mentioned. Illustrative are high-molecular compounds obtained by copolymerizing, for example, at least one monomer selected from the group consisting of methyl methacrylate and ethyl methacrylate, at least one hydrophobic monomer selected from the group consisting of various esters such as acrylate esters, methacrylate esters, crotonate esters, itaconate esters, maleate esters and fumarate esters, a monomer having one or more nonionic hydrophilic group, and a monomer having one or more acidic groups.

Among these high-molecular dispersants, desired from the standpoints of the color-developing property of printed images and the stability of the dispersed colorant particles are block copolymers comprising hydrophobic blocks formed from at least one vinyl ether and hydrophilic blocks formed from at least one vinyl ether, because these desired block copolymers are equipped with good compatibility with the polyol-alkylene oxide adduct. In particular, it is preferred when the hydrophilic blocks of such a high-molecular dispersant include at least blocks formed from a vinyl ether having one or more nonionic hydrophilic groups and blocks formed from a vinyl ether having one or more anionic hydrophilic groups. It is more preferred that such a high-molecular dispersant comprises a recurrence of at least a block formed from a hydrophobic vinyl ether, a block formed from a hydrophilic vinyl ether having one or more nonionic hydrophilic groups and a block formed from a hydrophilic vinyl ether having one or more anionic hydrophilic groups arranged in this order, because such a more preferred, high-molecular dispersant has still more improved compatibility with the polyol-alkylene oxide adduct.

The high-molecular dispersant for use in the present invention can preferably having a recurring unit structure represented, for example, by the following formula (1) is preferred:
—(CH₂—CH(OR¹))— (1)

In the above-described formula (1), R¹ represents an aliphatic hydrocarbon group such as an alkyl, alkenyl, cycloalkyl or cycloalkenyl group; or an aromatic hydrocarbon group one or more of the carbon atoms of which may be substituted by a like number of nitrogen atoms, such as a phenyl, pyridyl, benzyl, toluyl, xylyl, alkylphenyl, phenylalkyl, biphenyl or phenylpyridyl group. One or more of the hydrogen atoms on the aromatic ring may be substituted by a like number of hydrocarbon groups. The carbon number of R¹ may preferably range from 1 to 18.

R¹ can also be a group represented by —(CH(R²)—CH(R³)—O)ₚ—R⁴ or —(CH₂)ₘ—(O)ₙ—R⁴. In this case, R² and R³ each independently represents a hydrogen atom or a methyl group, and R⁴ represents an aliphatic hydrocarbon group such as an alkyl, alkenyl, cycloalkyl or cycloalkenyl group, an aromatic hydrocarbon group one or more of the carbon atoms of which may be substituted by a like number of nitrogen atoms, such as a phenyl, pyridyl, benzyl, toluyl, xylyl, alkylphenyl, phenylalkyl, biphenyl or phenylpyridyl group, with one or more hydrogen atoms on the aromatic ring being optionally substituted by a like number of hydrocarbon groups, —CHO, —CH₂CHO, —CO—CH═CH₂, —CO—C(CH₃)═CH₂, —CH₂—CH═CH₂, —CH₂—C(CH₃)═CH₂, CH₂—COOR⁵, or the like. In each of these groups, one or more hydrogen atoms may be substituted by a like number of halogen atoms such as fluorine, chlorine or bromine atoms to chemically feasible extent. The carbon number of R⁴ may preferably range from 1 to 18. R⁵ is a hydrogen atom or an alkyl group. Preferably, p can range from 1 to 18, m can range from 1 to 36, and n can be 0 or 1.

In R¹ and R⁴, examples of the alkyl and alkenyl groups can include methyl, ethyl, propyl, isopropyl, n-butyl, sec-butyl, t-butyl, pentyl, hexyl, heptyl, octyl, nonyl, decyl, dodecyl, tetradecyl, hexadecyl, octadecyl, oleyl and linoleyl, and examples of the cycloalkyl and cycloalkenyl groups can include cyclopropyl, cyclobutyl, cyclopentyl, cyclohexyl, cyclooctyl and cyclohexenyl.

The structures of vinyl monomers (I-a to I-o), which make up high-molecular dispersants useful in the present invention, and such high-molecular dispersants (II-a to II-e) will be exemplified below, although the polyvinyl ether structure in the high-molecular dispersant for use in the present invention is not limited to them.

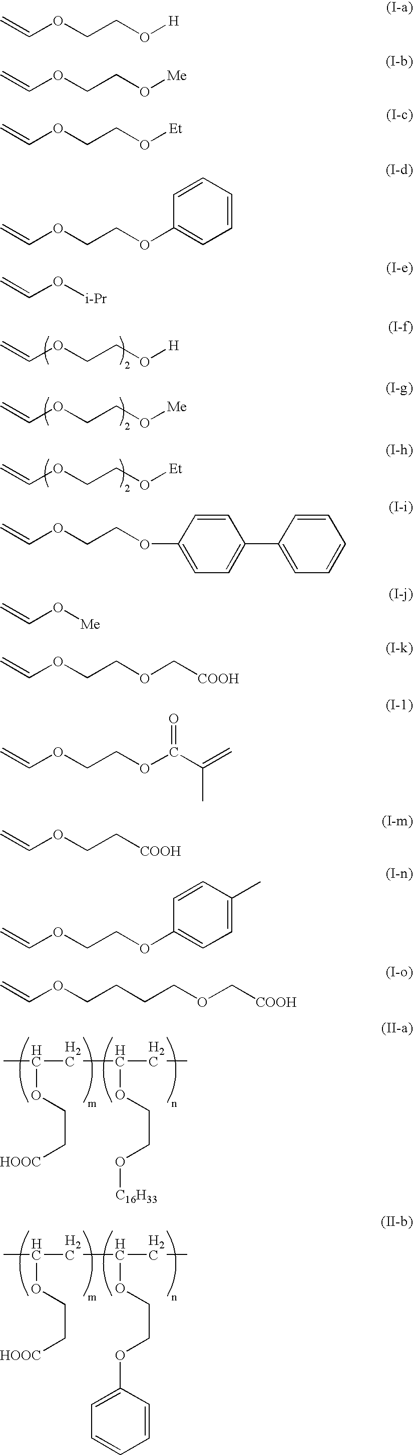

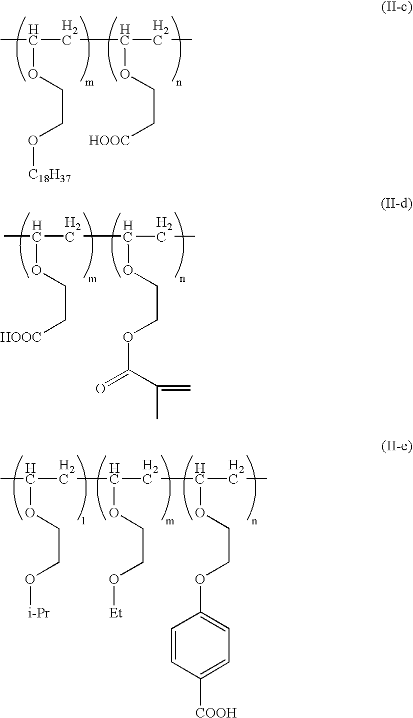

The preferred numbers of the recurring units in the respective polyvinyl ethers (i.e., m, n and l in the above-exemplified recurring units (II-a) to (II-e)) may each independently range from 1 to 10,000. More preferably, their total (i.e., m+n+l in the above-exemplified recurring units (II-a) to (II-e)) may range from 10 to 20,000. The number average molecular weight may range preferably from 500 to 20,000,000, more preferably from 1,000 to 5,000,000, most preferably from 2,000 to 2,000,000. Further, the proportion of the high-molecular dispersant in the ink may range preferably from 0.1 to 20 wt. %, more preferably from 0.5 to 10 wt. % based on the whole weight of the ink.

No particular limitation is imposed on the process for the synthesis of each copolymer (high-molecular dispersant) containing vinyl-ether-based polymer blocks, but the cation living polymerization developed by Aoshima, et al. (JP-A-11-322942, JP-A-11-322866) or the like can be suitably. The use of the cation polymerization process makes it possible to synthesize a variety of polymers, such as homopolymers, copolymers of two or more monomer components, block copolymers, graft copolymers and gradation copolymers, with their lengths (molecular weights) being each controlled precisely at the same value. Moreover, polyvinyl ethers allow to introduce various functional groups in their side chains.

As a neutralizing agent for the anionic hydrophilic groups in a high-molecular dispersant, any substance can be used insofar as it can neutralize the anionic hydrophilic group in the high-molecular dispersant and is soluble in water. Illustrative of such a neutralizing agent are alkali metals such as lithium, sodium and potassium; amines such as monoethanolamine and triethanolamine; and ammonia. However, the use of lithium or sodium is preferred because the resulting dispersed colorant particles can be provided with further improved stability.

(Water-Insoluble Colorant)

Any colorant can be employed in the ink according to the present invention insofar as it is substantially insoluble in water. Specifically, the colorant has a water solubility preferably of 0.5 wt. % or lower, more preferably of 0.1 wt. % or lower. As such colorants, oil-soluble dyes, vat dyes, disperse dyes, pigments and the like can be mentioned. Among these, pigments are more preferred because they can form stably-dispersed colorant particles with the above-described high-molecular dispersant. Examples of the water-insoluble colorant will be shown below although the present invention is not limited to them.

(Oil-Soluble Dyes)

C.I. Solvent Yellow 1, C.I. Solvent Yellow 2, C.I. Solvent Yellow 3, C.I. Solvent Yellow 13, C.I. Solvent Yellow 14, C.I. Solvent Yellow 19, C.I. Solvent Yellow 21, C.I. Solvent Yellow 22, C.I. Solvent Yellow 29, C.I. Solvent Yellow 36, C.I. Solvent Yellow 37, C.I. Solvent Yellow 38, C.I. Solvent Yellow 39, C.I. Solvent Yellow 40, C.I. Solvent Yellow 42, C.I. Solvent Yellow 43, C.I. Solvent Yellow 44, C.I. Solvent Yellow 45, C.I. Solvent Yellow 47, C.I. Solvent Yellow 62, C.I. Solvent Yellow 63, C.I. Solvent Yellow 71, C.I. Solvent Yellow 76, C.I. Solvent Yellow 79, C.I. Solvent Yellow 81, C.I. Solvent Yellow 82, C.I. Solvent Yellow 83:1, C.I. Solvent Yellow 85, C.I. Solvent Yellow 86, C.I. Solvent Yellow 88, C.I. Solvent Yellow 151; C.I. Solvent Red 8, C.I. Solvent Red 27, C.I. Solvent Red 35, C.I. Solvent Red 36, C.I. Solvent Red 37, C.I. Solvent Red 38, C.I. Solvent Red 39, C.I. Solvent Red 40, C.I. Solvent Red 49, C.I. Solvent Red 58, C.I. Solvent Red 60, C.I. Solvent Red 65, C.I. Solvent Red 69, C.I. Solvent Red 81, C.I. Solvent Red 83:1, C.I. Solvent Red 86, C.I. Solvent Red 89, C.I. Solvent Red 91, C.I. Solvent Red 92, C.I. Solvent Red 97, C.I. Solvent Red 99, C.I. Solvent Red 100, C.I. Solvent Red 109, C.I. Solvent Red 118, C.I. Solvent Red 119, C.I. Solvent Red 122, C.I. Solvent Red 127, C.I. Solvent Red 218; C.I. Solvent Blue 14, C.I. Solvent Blue 24, C.I. Solvent Blue 25, C.I. Solvent Blue 26, C.I. Solvent Blue 34, C.I. Solvent Blue 37, C.I. Solvent Blue 38, C.I. Solvent Blue 39, C.I. Solvent Blue 42, C.I. Solvent Blue 43, C.I. Solvent Blue 44, C.I. Solvent Blue 45, C.I. Solvent Blue 48, C.I. Solvent Blue 52, C.I. Solvent Blue 53, C.I. Solvent Blue 55, C.I. Solvent Blue 59, C.I. Solvent Blue 67, C.I. Solvent Blue 70; C.I. Solvent Black 3, C.I. Solvent Black 5, C.I. Solvent Black 7, C.I. Solvent Black 8, C.I. Solvent Black 14, C.I. Solvent Black 17, C.I. Solvent Black 19, C.I. Solvent Black 20, C.I. Solvent Black 22, C.I. Solvent Black 24, C.I. Solvent Black 26, C.I. Solvent Black 27, C.I. Solvent Black 28, C.I. Solvent Black 29, C.I. Solvent Black 43, C.I. Solvent Black 45; etc.

(Vat Dyes)

C.I. Vat Yellow 2, C.I. Vat Yellow 4, C.I. Vat Yellow 10, C.I. Vat Yellow 20, C.I. Vat Yellow 33; C.I. Vat Orange 1, C.I. Vat Orange 2, C.I. Vat Orange 3, C.I. Vat Orange 5, C.I. Vat Orange 7, C.I. Vat Orange 9, C.I. Vat Orange 13, C.I. Vat Orange 15; C.I. Vat Red 1, C.I. Vat Red 2, C.I. Vat Red 10, C.I. Vat Red 13, C.I. Vat Red 15, C.I. Vat Red 16, C.I. Vat Red 61; C.I. Vat Blue 1, C.I. Vat Blue 3, C.I. Vat Blue 4, C.I. Vat Blue 5, C.I. Vat Blue 6, C.I. Vat Blue 8, C.I. Vat Blue 12, C.I. Vat Blue 14, C.I. Vat Blue 18, C.I. Vat Blue 19, C.I. Vat Blue 20, C.I. Vat Blue 29, C.I. Vat Blue 35, C.I. Vat Blue 41; C.I. Vat Black 1, C.I. Vat Black 8, C.I. Vat Black 9, C.I. Vat Black 13, C.I. Vat Black 14, C.I. Vat Black 20, C.I. Vat Black 25, C.I. Vat Black 27, C.I. Vat Black 29, C.I. Vat Black 36, C.I. Vat Black 56, C.I. Vat Black 57, C.I. Vat Black 59, C.I. Vat Black 60; etc.

(Disperse Dyes)

C.I. Disperse Yellow 5, C.I. Disperse Yellow 42, C.I. Disperse Yellow 83, C.I. Disperse Yellow 93, C.I. Disperse Yellow 99, C.I. Disperse Yellow 198, C.I. Disperse Yellow 224; C.I. Disperse Orange 29, C.I. Disperse Orange 49, C.I. Disperse Orange 73; C.I. Disperse Red 92, C.I. Disperse Red 126, C.I. Disperse Red 145, C.I. Disperse Red 152, C.I. Disperse Red 159, C.I. Disperse Red 177, C.I. Disperse Red 181, C.I. Disperse Red 206, C.I. Disperse Red 283; C.I. Disperse Blue 60, C.I. Disperse Blue 87, C.I. Disperse Blue 128, C.I. Disperse Blue 154, C.I. Disperse Blue 201, C.I. Disperse Blue 214, C.I. Disperse Blue 224, C.I. Disperse Blue 257, C.I. Disperse Blue 287, C.I. Disperse Blue 368; etc.

(Pigments)

“Raven 760 Ultra”, “Raven 1060 Ultra”, “Raven 1080”, “Raven 1100 Ultra”, “Raven 1170”, “Raven 1200”, “Raven 1250”, “Raven 1255”, “Raven 1500”, “Raven 2000”, “Raven 2500 Ultra”, “Raven 3500”, “Raven 5250”, “Raven 5750”, “Raven 7000”, “Raven 5000 ULTRA-II”, “Raven 1190 ULTRA-II” (trade names, products of Columbian Carbon Co.); “Black Pearls-L”, “MOGUL-L”, “RegaL-400R”, “RegaL-660R”, “RegaL-330R”, “Monarch-800”, “Monarch-880”, “Monarch-900”, “Monarch-1000”, “Monarch-1300”, “Monarch-1400” (trade names, products of Cabot Corporation); “Color Black-FW1”, “Color Black-FW2”, “Color Black-FW200”, “Color Black-18”, “Color Black-S160”, “Color Black-S170”, “Special Black-4”, “Special Black-4A”, “Special Black-6”, “Special Black-550”, “Printex-35”, “Printex-45”, “Printex-55”, “Printex-85”, “Printex-95”, “Printex-U”, “Printex-140U”, “Printex-V”, “Printex-140V” (trade names, products of Degussa AG); “No. 25”, “No. 33”, “No. 40”, “No. 45”, “No. 47”, “No. 52”, “No. 900”, “No. 970”, “No. 2200B”, “No. 2300”, “No. 2400B”, “MCF-88”, “MA600”, “MA77”, “MA8”, “MA100”, “MA230”, “MA220” (trade names; products of Mitsubishi Chemical Corporation); C.I. Pigment Yellow 3, C.I. Pigment Yellow 12, C.I. Pigment Yellow 14, C.I. Pigment Yellow 17, C.I. Pigment Yellow 20, C.I. Pigment Yellow 24, C.I. Pigment Yellow 74, C.I. Pigment Yellow 83, C.I. Pigment Yellow 86, C.I. Pigment Yellow 93, C.I. Pigment Yellow 95, C.I. Pigment Yellow 97, C.I. Pigment Yellow 109, C.I. Pigment Yellow 110, C.I. Pigment Yellow 117, C.I. Pigment Yellow 120, C.I. Pigment Yellow 125, C.I. Pigment Yellow 128, C.I. Pigment Yellow 137, C.I. Pigment Yellow 138, C.I. Pigment Yellow 147, C.I. Pigment Yellow 148, C.I. Pigment Yellow 150, C.I. Pigment Yellow 151, C.I. Pigment Yellow 153, C.I. Pigment Yellow 154, C.I. Pigment Yellow 166, C.I. Pigment Yellow 168, C.I. Pigment Yellow 175, C.I. Pigment Yellow 180, C.I. Pigment Yellow 183, C.I. Pigment Yellow 184, C.I. Pigment Yellow 185; C.I. Pigment Orange 16, C.I. Pigment Orange 36, C.I. Pigment Orange 43, C.I. Pigment Orange 51, C.I. Pigment Orange 55, C.I. Pigment Orange 59, C.I. Pigment Orange 61, C.I. Pigment Orange 71; C.I. Pigment Red 9, C.I. Pigment Red 12, C.I. Pigment Red 48, C.I. Pigment Red 49, C.I. Pigment Red 52, C.I. Pigment Red 53, C.I. Pigment Red 57, C.I. Pigment Red 97, C.I. Pigment Red 122, C.I. Pigment Red 123, C.I. Pigment Red 149, C.I. Pigment Red 168, C.I. Pigment Red 175, C.I. Pigment Red 176, C.I. Pigment Red 177, C.I. Pigment Red 180, C.I. Pigment Red 184, C.I. Pigment Red 192, C.I. Pigment Red 202, C.I. Pigment Red 215, C.I. Pigment Red 216, C.I. Pigment Red 217, C.I. Pigment Red 220, C.I. Pigment Red 223, C.I. Pigment Red 224, C.I. Pigment Red 226, C.I. Pigment Red 227, C.I. Pigment Red 228, C.I. Pigment Red 238, C.I. Pigment Red 240, C.I. Pigment Red 254, C.I. Pigment Red 255, C.I. Pigment Red 272; C.I. Pigment Violet 19, C.I. Pigment Violet 23, C.I. Pigment Violet 29, C.I. Pigment Violet 30, C.I. Pigment Violet 32, C.I. Pigment Violet 37, C.I. Pigment Violet 40, C.I. Pigment Violet 50; C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, C.I. Pigment Blue 16, C.I. Pigment Blue 22, C.I. Pigment Blue 60, C.I. Pigment Blue 64; C.I. Pigment Green 7, C.I. Pigment Green 36; C.I. Pigment Brown 23, C.I. Pigment Brown 25, C.I. Pigment Brown 26; C.I. Pigment Black 1, C.I. Pigment Black 10, C.I. Pigment Black 31, C.I. Pigment Black 32; etc.

The content of the water-insoluble colorant in the ink according to the present invention may range preferably from 0.1 to 20 wt. %, more preferably from 1.0 to 10 wt. % based on the whole weight of the ink. With an ink in which the content of a water-insoluble colorant is lower than 0.1 wt. %, it may be difficult to obtain a sufficient color density in some instances. With an ink in which the content of a water-insoluble colorant is higher than 20 wt. %, on the other hand, a reduction tends to occur in the ejection stability due to the ink clogging or the like of nozzles. The content ratio of the water-insoluble colorant to the above-described high-molecular dispersant in the ink may desirably range from 100:1 to 1:2 in terms of solid weight ratio from the standpoints of the ejection stability and storage stability of the ink. These water-insoluble colorants may be used not only singly but also in combination.

The above-described materials are principal components of the ink of the present invention. It is, however, preferred to use a water-soluble organic soluble as needed in addition to these components. As the water-soluble organic solvent for use in the ink of the present invention, any organic solvent can be used insofar as it is soluble in water. Two or more water-soluble organic solvents can also be used in combination as a mixed solvent.

Specific examples of preferred water-soluble organic solvents can include lower alcohols such as methyl alcohol, ethyl alcohol, n-propyl alcohol, isopropyl alcohol, n-butyl alcohol, sec-butyl alcohol and tert-butyl alcohol; diols such as ethylene glycol, diethylene glycol, triethylene glycol, tetraethylene glycol, propylene glycol, dipropylene glycol, tripropylene glycol, 1,2-butanediol, 1,3-butanediol, 1,4-butanediol, thiodiglycol and 1,4-cyclohexanediol; triols such as glycerin, 1,2,4-butanetriol, 1,2,6-hexanetriol and 1,2,5-pentanetriol; hindered alcohols such as trimethylolpropane, trimethylolethane, neopentylglycol and pentaerythritol; glycol ethers such as ethylene glycol monomethyl ether, ethylene glycol monoethyl ether, ethylene glycol monoisoproyl ether, ethylene glycol monoallyl ether, diethylene glycol monomethyl ether, diethylene glycol monoethyl ether, diethylene glycol monobutyl ether, triethylene glycol monomethyl ether, triethylene glycol monoethyl ether, propylene glycol monomethyl ether and dipropylene glycol monomethyl ether; dimethylsulfoxide, glycerin monoallyl ether, polyethylene glycol, N-methyl-2-pyrrolidone, 2-pyrrolidone, γ-butyrolactone, 1,3-dimethyl-2-imidazolidinone, sulfolane, β-dihydroxyethylurea, urea, acetonylacetone, dimethylformamide, dimethylacetamide, acetone, and diacetone alcohol.

Among these, water-soluble organic solvents the boiling points of which are 120° C. or higher are preferred because their use can inhibit the ink concentration at nozzle tips. The proportion of such a water-soluble organic solvent in the ink may range preferably from 5 to 50 wt. %, more preferably from 10 to 30 wt. % based on the whole weight of the ink.

In addition to the above components, a variety of additives can be incorporated including surfactants, pH adjusters, antioxidants and antimolds. Among such additives, the incorporation of aluminum or an aluminum compound, for example, aluminum hydroxide, aluminum oxide, tripropyl aluminum, triisopropyl aluminum, an aluminum compound as a Ziegler-Natta catalyst, or metal aluminum powder, preferably aluminum hydroxide or aluminum oxide as an additive in the ink is desired, because the aluminum or aluminum compound acts on the hydrophobic blocks and hydrophilic blocks in the high-molecular dispersant such that the binding of molecules of the high-molecular dispersant is improved to further stabilize capsules of colorant particles in the high-molecular dispersant. The amount of this aluminum or aluminum compound to be added may desirably be at such a level that the molar ratio (A:B) of the high-molecular dispersant (A) to aluminum (B) in the ink ranges preferably from 3,000:1 to 1:5, more preferably from 300:1 to 20:1, because the capsules of colorant particles in the high-molecular dispersant are provided with improved stability.

The inkjet recording method according to the present invention is characterized in that upon conducting inkjet recording by applying energy to an ink to cause the ink to fly, the above-described ink of the present invention is used. Thermal energy or mechanical energy can be used as the energy, although the use of thermal energy is preferred.

No particular limitation is imposed on a recording medium in the inkjet recording method of the present invention. Nonetheless, a recording medium provided on at least one side thereof with an ink-receiving coating layer, such as so-called exclusive inkjet paper, postcard, business card paper sheet, label paper sheet, cardboard or inkjet film, can be used preferably. Desired is, for example, a recording medium provided on at least one side thereof with an ink-receiving coating layer which contains at least a hydrophilic polymer and/or an inorganic porous material.

As the inkjet recording system which performs recording by using the ink of the present invention, a general family printer employed primarily for A4-size paper sheets, a printer for business cards and other cards as prints, or a large office printer can be mentioned. Preferred embodiments of the inkjet recording system according to the present invention will be described hereinafter.

(Inkjet Recording System Making Use of Thermal Energy)

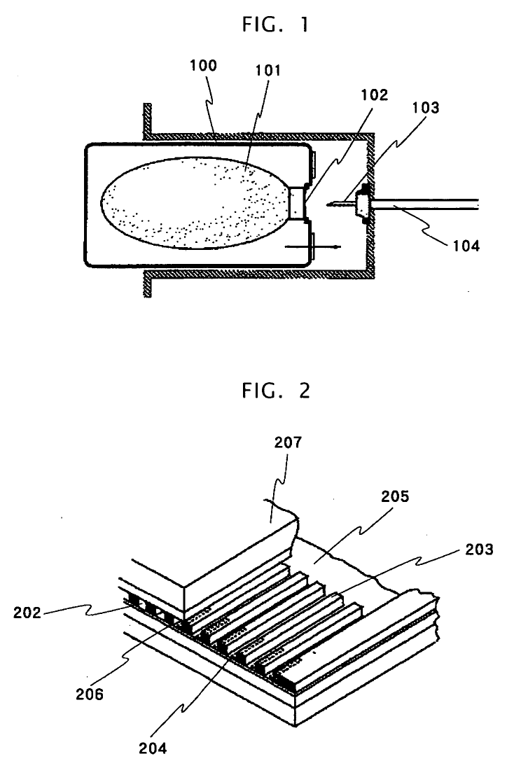

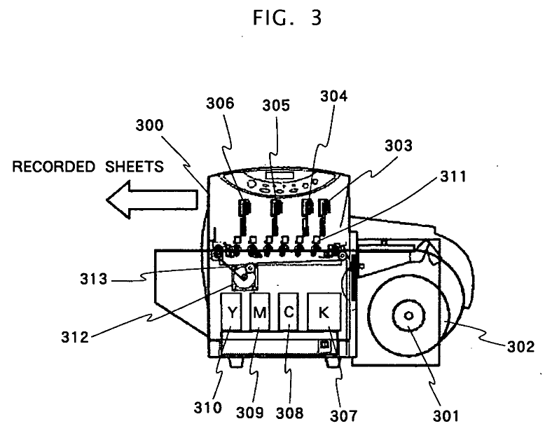

FIG. 1 illustrates an ink cartridge 100 with an ink filled therein in a form ready for being fed to a printhead via an ink feed tube 104. Designated at numeral 101 is an ink bag in which the ink is filled in a form ready for its feeding, and the ink bag 101 is provided at an open end thereof with a plug 102 made of chlorinated butyl rubber. By causing a needle 103 to penetrate through the plug 102, the ink inside the ink bag 101 can be fed to the corresponding one of the recording heads 303-306 (see FIG. 3). An ink absorber pad or the like can be arranged inside the ink cartridge to receive spent ink. The inkjet recording system useful in the present invention is not limited to one having recording heads and ink cartridges as discrete elements as described above, but one having them as integral elements can also be used suitably.

With reference to FIG. 2, the construction of each inkjet recording head employed in the inkjet recording system of this embodiment will be described. Individual nozzles 202 are provided with their corresponding heating elements (heaters) 204. By applying predetermined drive pulses to desired one of the heaters 204 from a recording head drive circuit (not shown), its corresponding nozzle 202 is heated to produce bubbles. Under the action of the bubbles, an ink droplet is ejected from the nozzle 202. It is to be noted that the heaters 204 can be formed on a silicon substrate 206 by a procedure similar to a semiconductor fabrication process. FIG. 2 also depicts nozzle partition walls 203 forming the individual nozzles 202, an ink manifold 205 for feeding the ink to the individual nozzles 202, and a top plate 207.

A partly “see-through” view of the recording system of this embodiment is shown in FIG. 3. A recording paper web 302 for the recording system 300 is paid out, for example, from a rolled-paper feeder unit 301, and is continuously conveyed by a conveyor unit arranged in the main body of the recording system 300. The conveyor unit is constructed of a conveyor motor 312, a conveyor belt 313, and so on. When an image cut-out position on the recording medium passes under the recording head 303 for a black color, the ejection of the black ink from the recording head is initiated. From the recording head 304 for a cyan color, the recording head 305 for a magenta color and the recording head 306 for a yellow color, the inks of the respective colors are selectively ejected likewise in this order to form a color image as a record.

In addition to these elements, the recording system 300 is also provided with capping mechanisms 311 for keeping the corresponding recording heads capped while they are standing by, ink cartridges 307-310 for feeding the inks to the respective recording heads 303-306, pump units (not shown) for feeding the inks and performing refreshing operations, a control board (not shown) for controlling the entire recording system, and the like.

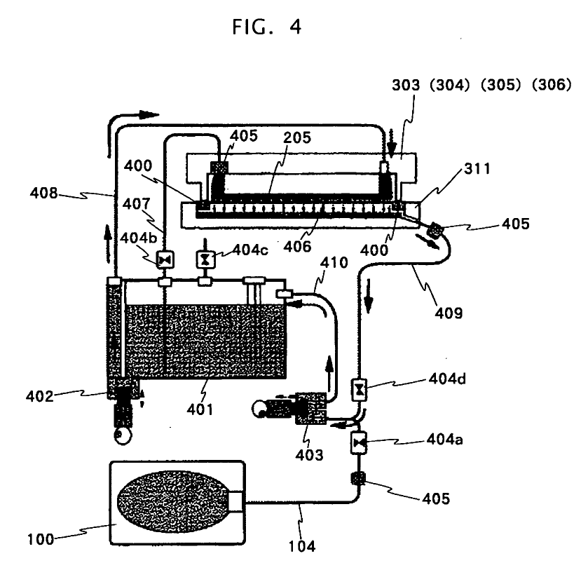

Referring next to FIG. 4, a description will be made about each refreshing system in the inkjet recording system of this embodiment. When the corresponding one of the recording heads 303-306 descends, its orifice plate is brought close to a cap 400 formed of chlorinated butyl rubber in the capping mechanism 311 so that predetermined refreshing operations can be performed.

An ink regeneration circuit unit in the refreshing system is constructed, as principal elements, of the ink cartridge 100 in which the ink to be fed as a replenishment is filled and stored in a polyethylene bag, a subtank 401 to be connected via a suction pump 403 and the like, a suction pump 403 arranged on an ink suction line 409 extending between the cap 400 and the subtank 401 and formed of polyvinyl chloride for recovering the ink from the capping mechanism 311 into the subtank 401, a filter 405 for removing dust and the like from the ink recovered from the cap 400, a booster pump 405 for feeding the ink via an ink feed line 408 to the ink manifold of the corresponding one of the recording heads 303-306, an ink feed line 407 for feeding to the subtank 401 the ink which has returned from the recording head, and valves 404a-404d.

Upon cleaning each of the recording heads 303-306, the valve 404b is closed and the booster pump 402 is operated. Therefore, the ink is fed under pressure from the subtank 401 into the recording head and is then forced to flow out of nozzles 406. As a result, bubbles, ink, dust and the like are discharged form the interiors of the nozzles of the recording head. The suction pump 403 recovers the ink, which has been discharged from the recording head into the capping mechanism 311, in the subtank 401 via the ink suction line 409 and an ink return line 410.

(Inkjet Recording System Making Use of Mechanical Energy)

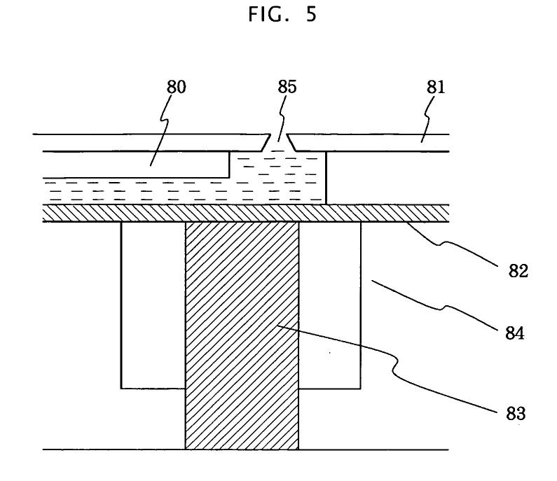

As a preferred embodiment of an inkjet recording system making use of mechanical energy, an on-demand inkjet recording head can be mentioned. This on-demand inkjet recording head is provided with a nozzle-defining plate (orifice plate) having plural nozzles therein, pressure producing elements arranged opposite the nozzles and composed of a piezoelectric material and a conductive material, and an ink filling up around these pressure producing elements. By impressed voltages, the pressure producing elements are caused to displace to eject small droplets of the ink from the nozzles. One example of the construction of the recording head as a principal element in the inkjet recording system is depicted in FIG. 5.

The recording head includes an ink channel 80 communicated with an ink manifold (not illustrated), an orifice plate 81 for ejecting ink droplets of a desired volume, a vibration plate 82 for applying a pressure directly to the ink, a piezoelectric element 83 bonded with the vibration plate 82 and displaceable by electrical signals, and a substrate 84 fixedly supporting the orifice plate 81, the vibration plate 82 and the like.

In FIG. 5, the ink channel 80 is formed of a photosensitive resin or the like, the orifice plate 81 defines ejection nozzles 85 formed by subjecting a metal such as stainless steel or nickel to orifice creation by electroforming or pressing, the vibration plate 82 is formed of a metal film such as a stainless steel, nickel or titanium film or a high-modulus resin film, and the piezoelectric element 83 is formed of a dielectric material such as barium titanate or PZT. The recording head of the above-described construction operates such that a pulsed voltage is applied across the piezoelectric element 83 to produce a stress deformation, its energy then deforms the vibration plate 82 bonded to the piezoelectric element 83, and hence, the ink within the ink channel 80 is vertically pressurized to eject an ink droplet (not shown) from the ejection orifice 85 of the orifice plate 81 to perform recording.

### EXAMPLES

Based on Examples, the present invention will hereinafter be described in detail. It is, however, to be noted that the present invention shall not be limited to the following Examples. In the following description, all designations of “part” or “parts” and “%” are on a weight basis unless otherwise specifically indicated.

(Preparation of a Polyol-Alkylene Oxide Adduct)

In an autoclave of 200 mL capacity fitted with a stirrer and a pressure gauge, 1,1,1-trimethylpropane (13.4 parts, 0.1 mole) and sodium tert-butoxide (0.1 part) were placed as a polyol and a reaction catalyst, respectively. Ethylene oxide (13.2 parts, 0.3 mole) which had been chilled with dry ice was then charged as an alkylene oxide into the autoclave. The autoclave was tightly closed, followed by thorough mixing with the stirrer. The autoclave was then heated with stirring to 135° C., and the heating was continued until the internal pressure of the autoclave dropped to become stable. Subsequently, the autoclave was cooled, and acetic acid was added to the reaction product to effect neutralization. Impurities were then eliminated by filtration and distillation to afford a trimethylolpropane-ethylene oxide (A). The thus-afforded trimethylolpropane-ethylene oxide (A) was analyzed by NMR spectroscopy, IR spectroscopy, gas chromatography and GPC to determine the number of added ethylene oxide units. As shown in Table 1, the number of added ethylene oxide units in the resultant trimethylolpropane-ethylene oxide adduct was three (3) times in moles as much as the trimethylolpropane employed as a raw material.

The polyol and alkylene oxide employed in the above-described procedure were changed as shown in Table 1 to prepare polyol-alkylene oxide adducts (B) to (H) in a similar manner as described above, and the numbers of added alkylene oxide units in those adducts (B) to (H) were also determined in a similar manner as described above.

TABLE 1

| | | | Number of added |
|---|---|---|---|
| | | | alkylene oxide units |
| Polyol- | | | (number of moles of |
| alkylene | | | added alkylene |
| oxide | | Alkylene | oxide units/number of |
| adduct | Polyol | oxide | moles of polyol) |
| A | 1,1,1-Trimethylolpropane | Ethylene | 3 |
| | | oxide | |
| B | 1,1,1-Trimethylolpropane | Ethylene | 9 |
| | | oxide | |
| C | 1,1,1-Trimethylolpropane | Ethylene | 30 |
| | | oxide | |
| D | 1,1,1-Trimethylolpropane | Ethylene | 60 |
| | | oxide | |
| E | Pentaerythritol | Ethylene | 10 |
| | | oxide | |
| F | Pentaerythritol | Ethylene | 16 |
| | | oxide | |
| G | 1,1,1-Trimethylolpropane | Propylene | 6 |
| | | oxide | |
| H | 1,1,1-Trimethylolpropane | Propylene | 9 |
| | | oxide | |

(Preparation of an Ethylene Oxide-Propylene Oxide Block Copolymer)

In an autoclave of 200 mL capacity fitted with a stirrer and a pressure gauge, polypropylene glycol (average number of propylene oxide units: 30, 17.6 parts, 0.01 mole) and sodium tert-butoxide (0.1 part) were placed as an alkylene oxide for central units in an ethylene oxide-propylene oxide block copolymer and a reaction catalyst, respectively. Ethylene oxide (13.2 parts, 0.3 mole) which had been chilled with dry ice was then charged into the autoclave as an alkylene oxide for both end units. The autoclave was tightly closed, followed by thorough mixing with the stirrer. The autoclave was then heated with stirring to 135° C., and the heating was continued until the internal pressure of the autoclave dropped to become stable. Subsequently, the autoclave was cooled, and acetic acid was added to the reaction product to effect neutralization. Impurities were then eliminated by filtration and distillation to afford the ethylene oxide-propylene oxide block copolymer (a). The thus-afforded ethylene oxide-propylene oxide block copolymer (a) was analyzed by NMR spectroscopy, IR spectroscopy, gas chromatography and GPC to determine the number of added ethylene oxide units. As shown in Table 2, the number of added ethylene oxide units in the resultant ethylene oxide-propylene oxide block copolymer (a) was thirty (30) times in moles as much as the polypropylene glycol employed as a raw material.

The alkylene oxide employed for the central units and the alkylene oxide used for both end units in the above-described procedure were changed as shown in Table 2 to prepare ethylene oxide-propylene oxide block copolymers (b) to (1) in a similar manner as described above, and the numbers of added alkylene oxide units in those adducts (B) to (H) were also determined in a similar manner as described above.

TABLE 2

| Ethylene | | | Number of | | Total number of |
|---|---|---|---|---|---|
| oxide-propylene | | | alkylene oxide | Alkylene oxide | alkylene oxide |
| oxide block | Structure of | Alkylene oxide | units as central | for both end | units as both end |
| copolymer | copolymer | for central units | units | units | units |
| a | Formula 2 | Propylene oxide | 30 | Ethylene oxide | 30 |
| | (EOₓ-PO_{y}-EO_{z}) | (PO) | | (EO) | |
| b | Formula 2 | Propylene oxide | 1 | Ethylene oxide | 58 |
| | (EOₓ-PO_{y}-EO_{z}) | (PO) | | (EO) | |
| c | Formula 2 | Propylene oxide | 26 | Ethylene oxide | 4 |
| | (EOₓ-PO_{y}-EO_{z}) | (PO) | | (EO) | |
| d | Formula 2 | Propylene oxide | 40 | Ethylene oxide | 100 |
| | (EOₓ-PO_{y}-EO_{z}) | (PO) | | (EO) | |
| e | Formula 2 | Propylene oxide | 50 | Ethylene oxide | 40 |
| | (EOₓ-PO_{y}-EO_{z}) | (PO) | | (EO) | |
| f | Formula 3 | Ethylene oxide | 2 | Propylene oxide | 20 |
| | (POₓ-EO_{y}-PO_{z}) | (EO) | | (PO) | |
| g | Formula 3 | Ethylene oxide | 10 | Propylene oxide | 28 |
| | (POₓ-EO_{y}-PO_{z}) | (EO) | | (PO) | |
| h | Formula 3 | Ethylene oxide | 10 | Propylene oxide | 40 |
| | (POₓ-EO_{y}-PO_{z}) | (EO) | | (PO) | |
| i | Formula 3 | Ethylene oxide | 26 | Propylene oxide | 30 |
| | (POₓ-EO_{y}-PO_{z}) | (EO) | | (PO) | |
| j | Formula 3 | Ethylene oxide | 30 | Propylene oxide | 2 |
| | (POₓ-EO_{y}-PO_{z}) | (EO) | | (PO) | |
| k | Formula 3 | Ethylene oxide | 40 | Propylene oxide | 100 |
| | (POₓ-EO_{y}-PO_{z}) | (EO) | | (PO) | |
| l | Formula 3 | Ethylene oxide | 50 | Propylene oxide | 60 |
| | (POₓ-EO_{y}-PO_{z}) | (EO) | | (PO) | |

### Example 1

(Preparation of a High-Molecular Dispersant 1)

Into a glass-made, 4-necked flask fitted with a reflux condenser, a dropping funnel, a thermometer and a stirrer, methyl ethyl ketone (300 parts) was charged, and with stirring, the flask was heated until a flowing back constantly took place from the reflux condenser. The internal temperature at that time was 84° C. To the content of the flask, a mixed solution of methyl methacrylate (250 parts), tert-octyl methacrylate (20 parts), triethylene glycol ethyl ether acrylate (40 parts), methacrylic acid (90 parts) and a polymerization initiator (“ABN-E”, trade name; product of Wako Pure Chemical Industries, Ltd.; 24 parts) was added dropwise at a constant rate over 180 minutes. After conducting aging for 30 minutes, a mixed solution of methyl ethyl ketone (100 parts) and “ABN-E” (2 parts) was added dropwise at a constant rate over 120 minutes. Subsequent to the completion of the dropwise addition, the internal temperature was maintained for 60 minutes. The contents of the flask were then cooled, followed by the addition of methyl ethyl ketone (100 parts) to produce a high-molecular dispersant 1. The weight average molecular weight of the high-molecular dispersant 1 was 15,000.

(Preparation of Dispersed Colorant Particles I)

The solution of the high-molecular dispersant 1 in methyl ethyl ketone and C.I. Pigment Blue 15:3, a commercial pigment, were charged into a kneader equipped with twin screws. After they were kneaded until they became a uniform mass, the kneader was depressurized with its internal temperature maintained at 80° C. such that the solvent was distilled off. Using a two-roll mill, the kneaded mass was formed into a sheet. A predetermined amount of deionized water and sodium hydroxide as a neutralizing agent were then added, and the resultant mixture was stirred to afford dispersed colorant particles I (pigment concentration: 10%, high-molecular dispersant concentration: 10%).

(Preparation of an ink 1)

| | | |
|---|---|---|
| Dispersed colorant particles I | 30.0 | parts |
| Glycerin | 5.0 | parts |
| Diethylene glycol | 10.0 | parts |
| Isopropyl alcohol | 3.0 | parts |
| Polyol-alkylene oxide adduct A | 0.5 | part |
| Ethylene oxide-propylene oxide | 0.5 | part |
| block copolymer b | | |
| Deionized water | 51.0 | parts |

The above components were combined and thoroughly mixed, and were then filtered through a microfilter of 3 μm pore size to afford the target ink.

### Example 2

(Preparation of an ink 2)

| | | |
|---|---|---|
| Dispersed colorant particles I | 30.0 | parts |
| Glycerin | 5.0 | parts |
| Diethylene glycol | 10.0 | parts |
| Isopropyl alcohol | 3.0 | parts |
| Polyol-alkylene oxide adduct D | 5.0 | parts |
| Ethylene oxide-propylene oxide | 0.5 | part |
| block copolymer a | | |
| Deionized water | 46.5 | parts |

The above components were combined and thoroughly mixed, and were then filtered through a microfilter of 3 μm pore size to afford the target ink.

### Example 3

(Preparation of a High-Molecular Dispersant 2)

Synthesis of an A-B Diblock Copolymer Formed of Hydrophobic Blocks and Hydrophilic Blocks:

A glass vessel fitted with a three-way cock was purged with nitrogen gas, and then, heated at 250° C. under a nitrogen gas atmosphere to remove any adsorbed water. After the system was allowed to cool down to room temperature, isobutyl vinyl ether (12 mmol), ethyl acetate (16 mmol), 1-isobutoxyethyl acetate (0.1 mmol) and toluene (11 cm³) were charged. When the internal temperature of the system had dropped to 0° C., ethyl aluminum sesquichloride (0.2 mmol) was added to initiate polymerization, and the A blocks of an A-B diblock copolymer were synthesized.

Using a column chromatography (GPC), the molecular weight was monitored in a time division manner. Subsequent to the completion of the polymerization of the A blocks, a vinyl monomer (12 mmol) which had been obtained by silylating the hydroxyl group of 2-hydroxyethyl vinyl ether (B blocks) with trimethylchlorosilane was added to conduct synthesis of the B blocks. Termination of the polymerization reaction was effected by adding into the system a 0.3% solution of ammonia in methanol, while the hydrolysis of the hydroxyl groups silylated with trimethylchlorosilane was effected by adding water. After completion of the reactions, dichloromethane was added to the reaction mixture to dilute the same. The thus-diluted reaction mixture was washed thrice with 0.6 N hydrochloric acid solution and then, thrice with distilled water. The reaction mixture was concentrated to dryness in an evaporator. The resulting solid matter was dried in vacuo to afford the A-B diblock copolymer (high-molecular dispersant 2). Identification of the compound was conducted using NMR and GPC. Its number average molecular weight (Mn) was 3.7×10⁴, and the ratio (Mw/Mn) of its weight average molecular weight (Mw) to its number average molecular weight (Mn), which indicates the degree of its molecular weight distribution, was 1.3.

(Preparation of Dispersed Colorant Particles II)

C.I. Pigment Blue 15:3, a commercial pigment, (10.0 parts) and tetrahydrofuran (90.0 parts) were combined and then heated to 40° C., at which they were thoroughly stirred to have the pigment dispersed evenly. The mixed solution was added to a solution of the high-molecular dispersant 2 (10.0 parts) in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles II (pigment concentration: 10%, high-molecular dispersant concentration: 10%).

(Preparation of an ink 3)

| | | |
|---|---|---|
| Dispersed colorant particles II | 30.0 | parts |
| Glycerin | 5.0 | parts |
| Diethylene glycol | 10.0 | parts |
| Isopropyl alcohol | 3.0 | parts |
| Polyol-alkylene oxide adduct E | 10.0 | parts |
| Ethylene oxide-propylene oxide | 0.1 | part |
| block copolymer 1 | | |
| 0.001% Aqueous solution of | 0.1 | part |
| aluminum hydroxide | | |
| Deionized water | 41.8 | parts |

The above components were combined and thoroughly mixed, and were then filtered through a microfilter of 3 μm pore size to afford the target ink.

### Example 4

(Preparation of an ink 4)

| | | |
|---|---|---|
| Dispersed colorant particles II | 30.0 | parts |
| Glycerin | 5.0 | parts |
| Diethylene glycol | 10.0 | parts |
| Isopropyl alcohol | 3.0 | parts |
| Polyol-alkylene oxide adduct E | 7.0 | parts |
| Ethylene oxide-propylene oxide | 0.3 | part |
| block copolymer e | | |
| 0.001% Aqueous solution of | 0.1 | part |
| aluminum hydroxide | | |
| Deionized water | 44.6 | parts |

The above components were combined and thoroughly mixed, and were then filtered through a microfilter of 3 μm pore size to afford the target ink.

### Example 5

(Preparation of an ink 5)

| | | |
|---|---|---|
| Dispersed colorant particles II | 30.0 | parts |
| Glycerin | 5.0 | parts |
| Diethylene glycol | 10.0 | parts |
| Isopropyl alcohol | 3.0 | parts |
| Polyol-alkylene oxide adduct E | 3.0 | parts |
| Ethylene oxide-propylene oxide | 0.5 | part |
| block copolymer f | | |
| 0.001% Aqueous solution of | 0.1 | part |
| aluminum hydroxide | | |
| Deionized water | 48.4 | parts |

The above components were combined and thoroughly mixed, and were then filtered through a microfilter of 3 μm pore size to afford the target ink.

### Example 6

(Preparation of an ink 6)

| | | |
|---|---|---|
| Dispersed colorant particles II | 30.0 | parts |
| Ethylene glycol | 7.0 | parts |
| Dipropylene glycol | 5.0 | parts |
| Triethylene glycol | 8.0 | parts |
| Polyol-alkylene oxide adduct F | 2.0 | parts |
| Ethylene oxide-propylene oxide | 0.4 | part |
| block copolymer d | | |
| 0.001% Aqueous solution of | 0.1 | part |
| aluminum hydroxide | | |
| Deionized water | 47.5 | parts |

The above components were combined and thoroughly mixed, and were then filtered through a microfilter of 3 μm pore size to afford the target ink.

### Example 7

(Preparation of a High-Molecular Dispersant 3)

Synthesis of an A-B-C Triblock Copolymer Formed of One Type of Hydrophobic Blocks and Two Types of Hydrophilic Blocks:

A glass vessel fitted with a three-way cock was purged with nitrogen gas, and then, heated at 250° C. under a nitrogen gas atmosphere to remove any adsorbed water. After the system was allowed to cool down to room temperature, n-octadecyl vinyl ether (12 mmol), ethyl acetate (16 mmol), 1-isobutoxyethyl acetate (0.1 mmol) and toluene (11 cm³) were charged. When the internal temperature of the system had dropped to 0° C., ethyl aluminum sesquichloride (0.2 mmol) was added to initiate polymerization, and the A blocks of an A-B-C triblock copolymer was synthesized.

Using a column chromatography (GPC), the molecular weight was monitored in a time division manner. Subsequent to the completion of the polymerization of the A blocks, 2-(2-(2-(2-methoxyethoxy)ethoxy)ethoxy)ethoxyvinyl ether (B blocks) (24 mmol) was added, followed by continuation of polymerization. Using GPC, the molecular weight was monitored likewise. Subsequent to the completion of the polymerization of the B blocks, a vinyl monomer (12 mmol) which had been obtained by esterifying the carboxyl group of 6-(2-vinyloxyethoxy)hexanoic acid (C blocks) with an ethyl group was added to conduct the synthesis of C blocks. Termination of the polymerization reaction was effected by adding into the system a 0.3% solution of ammonia in methanol. The esterified carboxyl group was converted into a carboxyl group by hydrolyzing it with a solution of sodium hydroxide in methanol. Subsequently, the procedure of Example 1 was followed likewise to afford the A-B-C triblock copolymer (high-molecular dispersant 3). Identification of the compound was conducted using NMR and GPC. Its number average molecular weight (Mn) was 3.7×10⁴, and the ratio (Mw/Mn) of its weight average molecular weight (Mw) to its number average molecular weight (Mn), which indicates the degree of its molecular weight distribution, was 1.2.

(Preparation of Dispersed Colorant Particles III)

C.I. Pigment Red 122, a commercial pigment, (10.0 parts) and tetrahydrofuran (90.0 parts) were combined and then heated to 40° C., at which they were thoroughly stirred to have the pigment dispersed evenly. The mixed solution was added to a solution of the high-molecular dispersant 3 (10.0 parts) in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles III (pigment concentration: 10%, high-molecular dispersant concentration: 10%).

(Preparation of an ink 7)

| | | |
|---|---|---|
| Dispersed colorant particles III | 30.0 | parts |
| Ethylene glycol | 7.0 | parts |
| Dipropylene glycol | 5.0 | parts |
| Triethylene glycol | 8.0 | parts |
| Polyol-alkylene oxide adduct F | 2.0 | parts |
| Ethylene oxide-propylene oxide | 0.4 | part |
| block copolymer k | | |
| 0.001% Aqueous solution of | 0.1 | part |
| aluminum hydroxide | | |
| Deionized water | 47.5 | parts |

The above components were combined and thoroughly mixed, and were then filtered through a microfilter of 3 μm pore size to afford the target ink.

### Example 8

(Preparation of an ink 8)

| | | |
|---|---|---|
| Dispersed colorant particles III | 30.0 | parts |
| Ethylene glycol | 7.0 | parts |
| Dipropylene glycol | 5.0 | parts |
| Triethylene glycol | 8.0 | parts |
| Polyol-alkylene oxide adduct C | 0.5 | part |
| Ethylene oxide-propylene oxide | 0.5 | part |
| block copolymer c | | |
| 0.001% Aqueous solution of | 0.1 | part |
| aluminum hydroxide | | |
| Deionized water | 48.9 | parts |

The above components were combined and thoroughly mixed, and were then filtered through a microfilter of 3 μm pore size to afford the target ink.

### Example 9

(Preparation of an ink 9)

| | | |
|---|---|---|
| Dispersed colorant particles III | 30.0 | parts |
| Ethylene glycol | 7.0 | parts |
| Dipropylene glycol | 5.0 | parts |
| Triethylene glycol | 8.0 | parts |
| Polyol-alkylene oxide adduct B | 4.0 | parts |
| Ethylene oxide-propylene oxide | 0.5 | part |
| block copolymer j | | |
| 0.001% Aqueous solution of | 0.1 | part |
| aluminum hydroxide | | |
| Deionized water | 45.4 | parts |

The above components were combined and thoroughly mixed, and were then filtered through a microfilter of 3 μm pore size to afford the target ink.

### Example 10

(Preparation of Dispersed Colorant Particles IV)

C.I. Pigment Yellow 93, a commercial pigment, (10.0 parts) and tetrahydrofuran (90.0 parts) were combined and then heated to 40° C., at which they were thoroughly stirred to have the pigment dispersed evenly. The mixed solution was added to a solution of the high-molecular dispersant 3 (10.0 parts) in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles IV (pigment concentration: 10%, high-molecular dispersant concentration: 10%).

(Preparation of an ink 10)

| | | |
|---|---|---|
| Dispersed colorant particles IV | 40.0 | parts |
| Diethylene glycol | 6.0 | parts |
| Triethylene glycol | 8.0 | parts |
| 2-Pyrrolidone | 6.0 | parts |
| Polyol-alkylene oxide adduct H | 5.0 | parts |
| Ethylene oxide-propylene oxide | 1.2 | parts |
| block copolymer i | | |
| 0.001% Aqueous solution of | 0.1 | part |
| aluminum hydroxide | | |
| Deionized water | 33.7 | parts |

The above components were combined and thoroughly mixed, and were then filtered through a microfilter of 3 μm pore size to afford the target ink.

### Example 11

(Preparation of Dispersed Colorant Particles V)

Carbon black, a commercial pigment (“MA100”, trade name; product of Mitsubishi Chemical Corporation), (10.0 parts) and tetrahydrofuran (90.0 parts) were combined and then heated to 40° C., at which they were thoroughly stirred to have the pigment dispersed evenly. The mixed solution was added to a solution of the high-molecular dispersant 3 (10.0 parts) in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles V (pigment concentration: 10%, high-molecular dispersant concentration: 10%).

(Preparation of an ink 11)

| | | |
|---|---|---|
| Dispersed colorant particles V | 40.0 | parts |
| Diethylene glycol | 6.0 | parts |
| Triethylene glycol | 8.0 | parts |
| 2-Pyrrolidone | 6.0 | parts |
| Polyol-alkylene oxide adduct G | 5.0 | parts |
| Ethylene oxide-propylene oxide | 0.4 | part |
| block copolymer g | | |
| 0.001% Aqueous solution of | 0.1 | part |
| aluminum hydroxide | | |
| Deionized water | 34.5 | parts |

The above components were combined and thoroughly mixed, and were then filtered through a microfilter of 3 μm pore size to afford the target ink.

### Example 12

(Preparation of Dispersed Colorant Particles VI)

C.I. Pigment Blue 15:3, a commercial pigment, (10.0 parts) and tetrahydrofuran (90.0 parts) were combined and then heated to 40° C., at which they were thoroughly stirred to have the pigment dispersed evenly. The mixed solution was added to a solution of the high-molecular dispersant 3 (10.0 parts) in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles VI (pigment concentration: 10%, high-molecular dispersant concentration: 10%).

(Preparation of an ink 12)

| | | |
|---|---|---|
| Dispersed colorant particles VI | 25.0 | parts |
| Diethylene glycol | 6.0 | parts |
| Tripropylene glycol | 4.0 | parts |
| Triethylene glycol | 8.0 | parts |
| Polyol-alkylene oxide adduct G | 4.0 | parts |
| Ethylene oxide-propylene oxide | 0.5 | part |
| block copolymer h | | |
| 0.001% Aqueous solution of | 0.1 | part |
| aluminum hydroxide | | |
| Deionized water | 52.4 | parts |

The above components were combined and thoroughly mixed, and were then filtered through a microfilter of 3 μm pore size to afford the target ink.

### Comparative Example 1

(Preparation of an ink 13)

| | | |
|---|---|---|
| Dispersed colorant particles I | 30.0 | parts |
| Glycerin | 5.0 | parts |
| Diethylene glycol | 10.0 | parts |
| Isopropyl alcohol | 3.0 | parts |
| Polyol-alkylene oxide adduct A | 4.0 | parts |
| Deionized water | 48.0 | parts |

The above components were combined and thoroughly mixed, and were then filtered through a microfilter of 3 μm pore size to afford the target ink.

### Comparative Example 2

(Preparation of an ink 14)

| | | |
|---|---|---|
| Dispersed colorant particles I | 30.0 | parts |
| Glycerin | 5.0 | parts |
| Diethylene glycol | 10.0 | parts |
| Isopropyl alcohol | 3.0 | parts |
| Polyol-alkylene oxide adduct B | 4.0 | parts |
| Deionized water | 48.0 | parts |

The above components were combined and thoroughly mixed, and were then filtered through a microfilter of 3 μm pore size to afford the target ink.

### Comparative Example 3

(Preparation of Dispersed Colorant Particles VII)

C.I. Pigment Red 122, a commercial pigment, (10.0 parts) and tetrahydrofuran (90.0 parts) were combined and then heated to 40° C., at which they were thoroughly stirred to have the pigment dispersed evenly. The mixed solution was added to a solution of an n-butyl methacrylate-methacrylic acid block copolymer (molar ratio: n-butyl methacrylate/methacrylic acid=1/1, Mn: 2,500; 10.0 parts) as a high-molecular dispersant in tetrahydrofuran (90.0 parts). They were then mixed, followed by the addition of an aqueous sodium hydroxide solution (80.0 parts) which contained sodium in an equivalent amount as a neutralizing agent for the anionic hydrophilic groups in the high-molecular dispersant. Subsequently, tetrahydrofuran was driven off by a rotary evaporator to afford dispersed colorant particles VII (pigment concentration: 10%, high-molecular dispersant concentration: 10%).

(Preparation of an ink 15)

| | | |
|---|---|---|
| Dispersed colorant particles VII | 30.0 | parts |
| Glycerin | 5.0 | parts |
| Diethylene glycol | 10.0 | parts |
| Isopropyl alcohol | 3.0 | parts |
| Polyol-alkylene oxide adduct B | 4.0 | parts |
| Deionized water | 48.0 | parts |

The above components were combined and thoroughly mixed, and were then filtered through a microfilter of 3 μm pore size to afford the target ink.

### Comparative Example 4

(Preparation of an ink 16)

| | | |
|---|---|---|
| Dispersed colorant particles I | 30.0 | parts |
| Glycerin | 5.0 | parts |
| Diethylene glycol | 10.0 | parts |
| Isopropyl alcohol | 3.0 | parts |
| Polyol-alkylene oxide adduct E | 4.0 | parts |
| Deionized water | 42.0 | parts |

The above components were combined and thoroughly mixed, and were then filtered through a microfilter of 3 μm pore size to afford the target ink.

### Comparative Example 5

(Preparation of an ink 17)

| | | |
|---|---|---|
| Dispersed colorant particles I | 30.0 | parts |
| Diethylene glycol | 6.0 | parts |
| Tripropylene glycol | 4.0 | parts |
| Triethylene glycol | 8.0 | parts |
| Polyol-alkylene oxide adduct G | 4.0 | parts |
| Deionized water | 48.0 | parts |

The above components were combined and thoroughly mixed, and were then filtered through a microfilter of 3 μm pore size to afford the target ink.

### Comparative Example 6

(Preparation of an ink 18)

| | | |
|---|---|---|
| Dispersed colorant particles I | 30.0 | parts |
| Diethylene glycol | 6.0 | parts |
| Tripropylene glycol | 4.0 | parts |
| Triethylene glycol | 8.0 | parts |
| Ethylene oxide-propylene oxide | 0.5 | part |
| Block copolymer a | | |
| Deionized water | 51.5 | parts |

The above components were combined and thoroughly mixed, and were then filtered through a microfilter of 3 μm pore size to afford the target ink.

(Ranking)

The inks of Examples 1 to 12 and those of Comparative Examples 1 to 6 were tested for ejection stability, the color-developing property of printed images, and dispersion stability. With respect to the color-developing property and ejection stability, each ink was loaded on an inkjet recording system equipped with on-demand multiple-nozzle recording heads that eject inks by applying to the inks thermal energies corresponding to recording signals (“P-660 CII”, trade name, manufactured by Canon Finetech Inc.), and printing was performed on glossy paper, “SP101” (trade name, product of Canon Inc.), to rank the ink. As shown in Table 3, the inks of all the Examples gave better dispersion stability and ejection stability than the inks of the Comparative Examples. Further, the inks of the Examples all gave good results in the color-developing property of printed images.

TABLE 3-1

| | | | Ethylene oxide-propylene oxide block | | |
|---|---|---|---|---|---|
| | | Ethylene | copolymer/polyol-alkylene oxide adduct | | |
| | Polyol-alkylene | oxide-propylene | | | Total number |
| | oxide adduct | oxide block | Unit number | | ratio of units |
| | (a) | copolymer (b) | ratio*1 | Weight ratio*2 | in ink*3 |
| Example 1 | A | b | 19.7 | 1.00 | 1.99 |
| Example 2 | D | a | 1.0 | 0.10 | 0.09 |
| Example 3 | E | l | 11.0 | 0.01 | 0.01 |
| Example 4 | E | e | 9.0 | 0.04 | 0.05 |
| Example 5 | E | f | 2.2 | 0.17 | 0.17 |
| Example 6 | F | d | 8.8 | 0.20 | 0.22 |
| Example 7 | F | k | 8.8 | 0.20 | 0.19 |
| Example 8 | C | c | 1.0 | 1.00 | 0.85 |
| Example 9 | B | j | 3.6 | 0.13 | 0.16 |
| Example 10 | H | i | 6.2 | 0.24 | 0.34 |
| Example 11 | G | g | 6.3 | 0.08 | 0.12 |
| Example 12 | G | h | 8.3 | 0.13 | 0.18 |
| Comp. Ex. 1 | A | None | — | — | — |
| Comp. Ex. 2 | B | None | — | — | — |
| Comp. Ex. 3 | B | None | — | — | — |
| Comp. Ex. 4 | E | None | — | — | — |
| Comp. Ex. 5 | G | None | — | — | — |
| Comp. Ex. 6 | None | a | — | — | — |

TABLE 3-2

| | Intermittent | Continuous | Color- | |
|---|---|---|---|---|
| | ejection | ejection | developing | Dispersion |
| | stability *4 | stability *5 | property *6 | stability *7 |
| Example 1 | B | B | B | B |
| Example 2 | B | B | B | B |
| Example 3 | B | B | A | B |
| Example 4 | B | B | B | A |
| Example 5 | A | B | B | A |
| Example 6 | A | B | A | B |
| Example 7 | A | B | B | A |
| Example 8 | A | B | A | A |
| Example 9 | A | B | A | A |
| Example 10 | A | A | A | A |
| Example 11 | A | A | A | A |
| Example 12 | A | A | A | A |
| Comp. Ex. 1 | D | D | B | C |
| Comp. Ex. 2 | D | D | B | C |
| Comp. Ex. 3 | D | D | B | C |
| Comp. Ex. 4 | C | D | B | C |
| Comp. Ex. 5 | C | D | B | B |
| Comp. Ex. 6 | B | C | C | B |

*1: Unit number ratio

A value obtained by calculating the ratio of the number of alkylene oxide units in an ethylene oxide-propylene oxide block copolymer to the number of alkylene oxide units in a polyol-alkylene oxide adduct in accordance with the following formula:
Unit number ratio=the average number of alkylene oxide units in the ethylene oxide-propylene oxide block copolymer (b)/the average number of alkylene oxide units in the polyol-alkylene oxide adduct (a)
*2: Weight Ratio

A value obtained by calculating the weight ratio of an ethylene oxide-propylene oxide block copolymer to a polyol-alkylene oxide adduct in accordance with the following formula:
Weight ratio=the weight of the ethylene oxide-propylene oxide block copolymer (b) in an ink/the weight of the polyol-alkylene oxide adduct (a) in the ink
*3: Total Number Ratio of Units in Ink

A value obtained by calculating the ratio of the total number of alkylene oxide units in an ethylene oxide-propylene oxide block copolymer to the total number of alkylene oxide units in a polyol-alkylene oxide adduct in an ink in accordance with the following formula:
Total number ratio of units in ink=the total number of alkylene oxide units in the ethylene oxide-propylene oxide block copolymer (b) in the ink/the total number of alkylene oxide units in the polyol-alkylene oxide adduct (a) in the ink
*4: Intermittent Ejection Stability

After each ink was stored at 60° C. for 2 months, a 100% solid image was printed under an environment of 15° C. and 10% R.H. After the printing was stopped for 3 minutes, a 100% solid image was printed again. The latter 100% solid image was ranked in accordance with the following ranking standards.
A: Normally printed without any white streak.
B: Slight white streaks were observed at the beginning of the print.
C: White streaks were observed over the entire image.
D: Practically no image was printed.
   *5: Continuous Ejection Stability

A gradation pattern of the postcard size was continuously printed 1,000 sheets, and the image on the 1,000^{th} sheet was ranked in ejection performance of misalignments and non-ejection in accordance with the following ranking standards.
A: Normally printed without any misalignments or non-ejection.
B: Misalignments were observed at some parts although no non-ejection took place.
C: Non-ejection took place at some parts, and misalignments were observed over the entire image.
D: Non-ejection took place at many points, and misalignments were observed over the entire image.
   *6: Color-Developing Property

With each ink stored at 60° C. for 2 months, a 100% solid image was printed. The image was ranked in accordance with the following ranking standards.
A: No mottle was observed, and the chroma was high.
B: No mottle was observed, but the chroma was a little low.
C: Some mottles were observed.
D: Many mottles were observed, and in addition, the chroma was low.
   *7: Dispersion Stability

After each ink was stored under sealed conditions at 60° C. for 2 months, its particle size was measured. As an index of dispersion stability, a particle size increment (%) relative to the particle size before the test was determined in accordance with the below-described formula. For the measurement of those particle sizes, the dynamic light scattering method (“Laser Diffraction Particle Size Analyzer PAR III”, trade name; manufactured by Otsuka Electronics Co., Ltd.) was used. The below-described ranking standards were followed.
Particle size increment (%)=(Particle size after the test−Particle size before the test)/(Particle size before the test)×100

A: Particle size increment (%)<5%

B: 5%≦Particle size increment (%)<10%

C: 10%≦Particle size increment (%)<30%

D: 30%≦Particle size increment (%)

This application claims the priority of Japanese Patent Application 2005-013144 filed Jan. 20, 2005, which is incorporated herein by reference.

1. An inkjet recording ink comprising a high-molecular dispersant, a water-insoluble colorant, a co-solvent and water, wherein said co-solvent comprises:
(a) a polyol-alkylene oxide adduct, represented by the following formula 1: 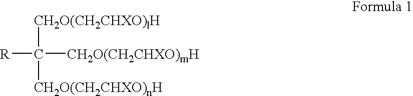
wherein R represents an alkyl group having a carbon number of not greater than 4 or —CH₂O(CH₂CHXO)ₖH in which X represents H or CH₃ and k is 1 to 20, and l+m+n is 3 to 60; and
(b) an ethylene oxide-propylene oxide block copolymer represented by the following formula 2 or 3:
HO(CH₂CH₂O)ₓ₁(C₃H₆O)_{y1}(CH₂CH₂O)_{z1}H Formula 2
wherein x1+z1 is an integer of from 4 to 100, and y1 is an integer of from 1 to 50, or
HO(C₃H₆O)ₓ₂(CH₂CH₂O)_{y2}(C₃H₆O)_{z2}H Formula 3
wherein x2+z2 is an integer of from 2 to 100, and y2 is an integer of from 2 to 50.

2. An inkjet recording ink according to claim 1, wherein said polyol-alkylene oxide adduct (a) is at least one adduct selected from the group consisting of a trimethylolpropane-ethylene oxide adduct (l+m+n=3 to 30), a trimethylolpropane-propylene oxide adduct (l+m+n=3 to 30) and a pentaerythritol-ethylene oxide adduct of (k+l+m+n=4 to 40).

3. An inkjet recording ink according to claim 1, wherein a ratio of an average number of alkylene oxide units in said ethylene oxide-propylene oxide block copolymer (b) to an average number of alkylene oxide units in said polyol-alkylene oxide adduct (a) is in a range of from 1 to 20.

4. An inkjet recording ink according to claim 1, wherein a ratio of a weight of said ethylene oxide-propylene oxide block copolymer (b) in said ink to a weight of said polyol-alkylene oxide adduct (a) in said ink is in a range of from 0.01 to 1.

5. An inkjet recording ink according to claim 1, wherein a ratio of a total number of alkylene oxide units in the ethylene oxide-propylene oxide block copolymer (b) in said ink to a total number of alkylene oxide units in the polyol-alkylene oxide adduct (a) in said ink is in a range of from 0.01 to 2.

6. An inkjet recording ink according to claim 1, wherein said high-molecular dispersant is a block copolymer comprising hydrophobic blocks formed from at least one vinyl ether and hydrophilic blocks formed from at least one vinyl ether.

7. An inkjet recording ink according to claim 6, wherein said hydrophilic blocks in said high-molecular dispersant comprise blocks formed from a vinyl ether having a nonionic hydrophilic group and blocks formed from a vinyl ether having an anionic hydrophilic group.

8. An inkjet recording ink according to claim 6, wherein said high-molecular dispersant is formed of a recurrence of at least a block formed from a hydrophobic vinyl ether, a block formed from a hydrophilic vinyl ether having a nonionic hydrophilic group and a block formed from a hydrophilic vinyl ether having an anionic hydrophilic group arranged in this order.

9. An inkjet recording ink according to claim 1, wherein said water-insoluble colorant is a pigment.

10. An inkjet recording method comprising applying energy to an ink to cause said ink to fly onto a recording material, wherein said ink is an inkjet recording ink according to claim 1.

11. An inkjet recording method according to claim 10, wherein said energy is thermal energy.

12. An inkjet recording method according to claim 10, wherein said recording material is provided on at least one side thereof with an ink-receiving coating layer.

13. An ink cartridge provided with an ink reservoir with an ink accommodated therein, wherein said ink is an inkjet recording ink according to claim 1.

14. An inkjet recording system having an ink cartridge provided with an ink reservoir with an ink accommodated therein and a printhead portion for ejecting said ink, wherein said ink is an inkjet recording ink according to claim 1.
